(19) United States
(12) Patent Application Publication
(10) Pub. No.: US 2016/0376792 A1
(43) Pub. Date: Dec. 29, 2016

(54) ROLL ROOFING MATERIAL APPLICATOR

(71) Applicant: Jon Danielson, Orcutt, CA (US)

(72) Inventor: Jon Danielson, Orcutt, CA (US)

(21) Appl. No.: 14/752,261

(22) Filed: Jun. 26, 2015

(51) Int. Cl. E04D 15/06; B32B 37/00; E04D 5/00; B32B 38/10

(52) U.S. Cl. CPC E04D 15/06; B32B 38/10; B32B 37/0053; E04D 5/00

(57) ABSTRACT

An applicator for roll roofing materials employs a frame with a support bar removably engaged on the frame. The support bar receives a roofing material roll. An application roller is supported from the frame in trailing engagement with a roofing surface. A take-up roller is supported by the frame onto which tear sheet from the roofing material roll is rolled. Wheels are attached to the frame and a drive system provides a drive pulley attached to a wheel, a driven pulley operationally attached to the take-up roller, and, a drive belt extending from the drive pulley to the driven pulley. The drive system is adapted for slippage upon the rolled tear sheet reaching a predetermined diameter.

### BACKGROUND INFORMATION

Field

Embodiments of the disclosure relate generally to the field of devices for roll roofing and more particularly to an applicator for roll roofing materials having a surface tear sheet removable to expose an adhesive layer with a take-up roller for the tear sheet driven by a slippable drive belt and pulley for roll diameter compensation.

Background

Roll roofing and underlayment with pre-applied adhesives and a backing or surface tear sheet are presently applied by unrolling the roofing or underlayment material and folding it in half to remove one half of the surface tear sheet. The material is then rotated to adhere the portion with the tear sheet removed after which the second half of the tear sheet is removed and the material unfolded to fully adhere the material to the roof. This limits the length of rolled sheet that can be applied due to practical handling issues and, even when accomplished properly, requires significant labor with the potential for error and rework due to undesired adherence of the adhesive during placement.

It is therefore desirable to provide an apparatus for applying adhesive backed roll roofing or underlayment in a continuing pass without requiring inverting the roll or cutting the roll into short lengths.

### SUMMARY

Exemplary embodiments provide an applicator for roll roofing and underlayment materials (jointly referred to hereinafter as “roofing material”) employing a frame with a support bar removably engaged on the frame. The support bar receives a roofing material roll. An application roller is supported from the frame in trailing engagement with a roofing surface. A take-up roller is supported by the frame onto which tear sheet from the roofing material roll is rolled. Wheels are attached to the frame and a drive system provides a drive pulley attached to a wheel, a driven pulley operationally attached to the take-up roller, and, a drive belt extending from the drive pulley to the driven pulley. The drive system is adapted for slippage upon the rolled tear sheet reaching a predetermined diameter.

### BRIEF DESCRIPTION OF THE DRAWINGS

The features and advantages of embodiments disclosed herein will be better understood by reference to the following detailed description when considered in connection with the accompanying drawings wherein:

FIG. 1 is perspective view of an exemplary embodiment;

FIG. 2 is an alternate perspective view of the embodiment of FIG. 1;

FIG. 3 is a detailed view of the embodiment showing the roofing material roll and tear sheet extraction;

FIG. 4 is a detailed view of the embodiment showing the roofing material roll being pressed into position with the application roller; and,

FIG. 5 is a flow chart of a method for implementation of the embodiment described herein.

### DETAILED DESCRIPTION

An exemplary embodiment disclosed herein provides an applicator for roll roofing materials having a surface tear sheet removable to expose an adhesive layer. The applicator allows continuous application of roofing material from a roll with coincident extraction of tear sheet material without inversion of the roofing material.

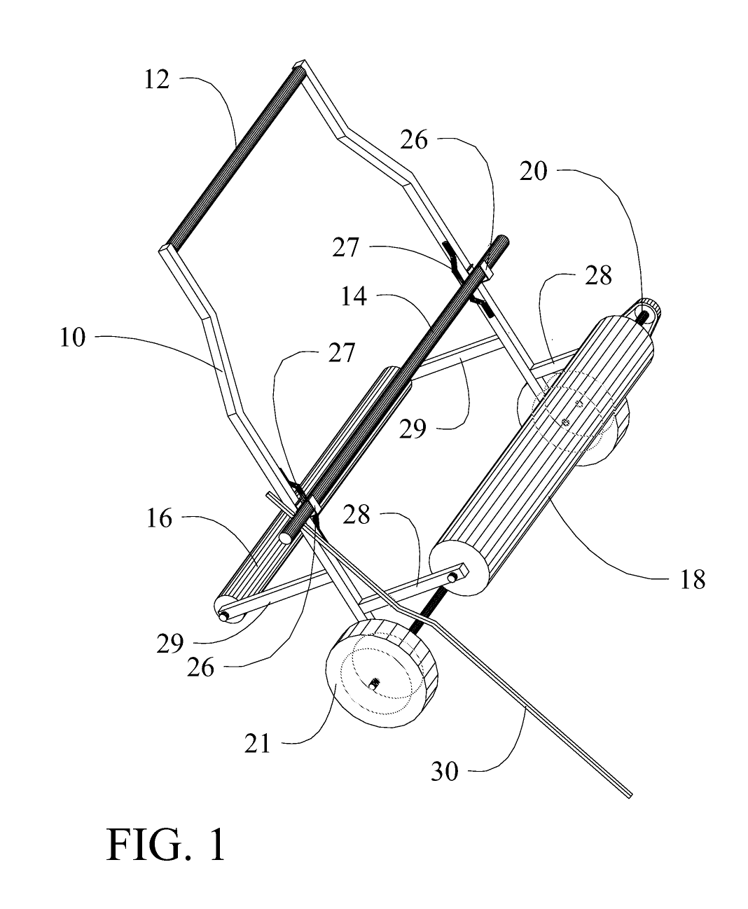

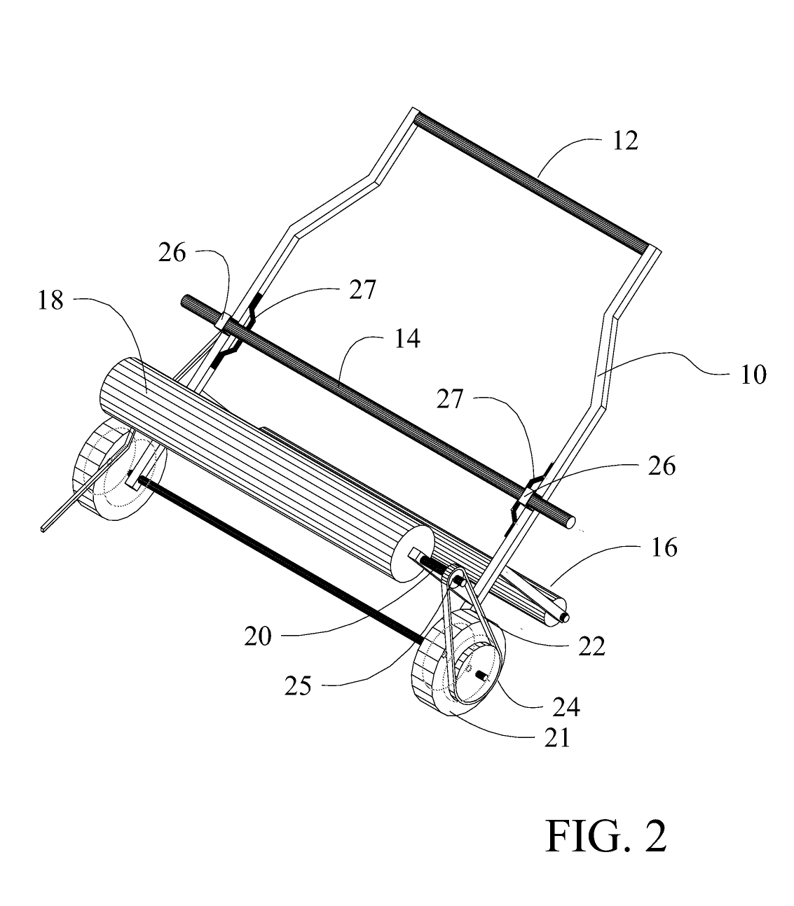

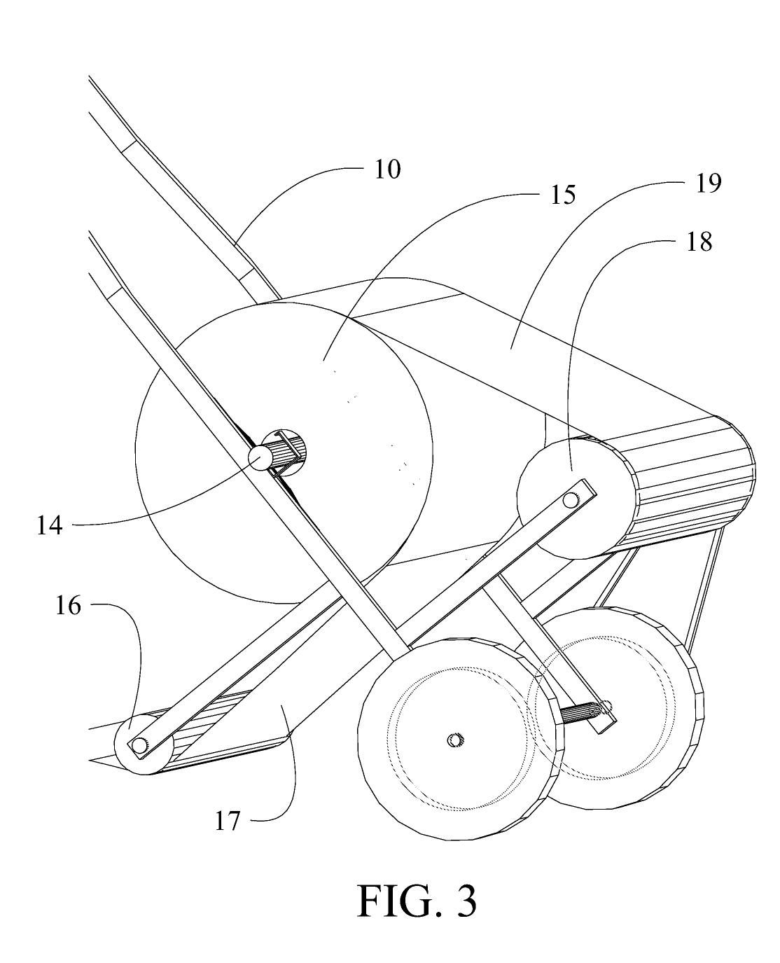

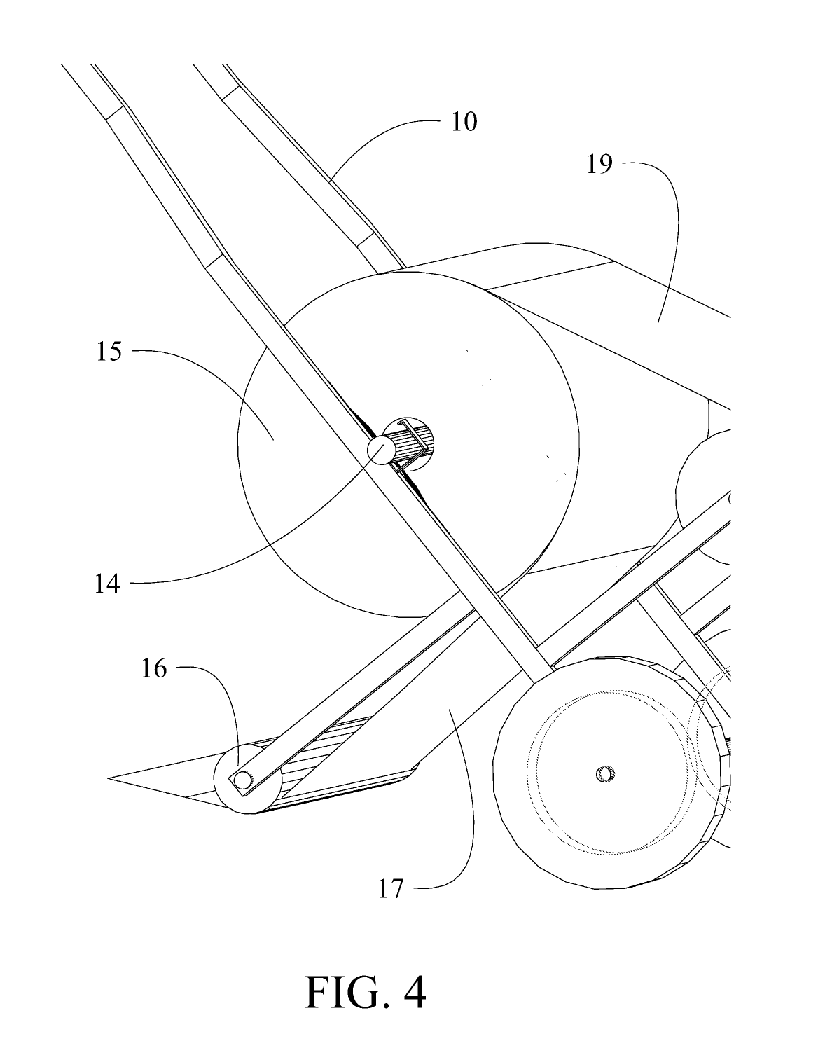

Referring to the drawings, as shown in FIGS. 1 and 2 (which show the applicator without the roll roofing and tear sheet) the applicator has a frame 10 with a handle 12. The frame 10 is formed for the embodiment shown from rectangular metal tubing. The frame 10 may be substantially rectangular in shape or may provide tapered or stepped insets to reduce the width of handle 12 as shown for the exemplary embodiment. A support bar 14 is engaged on the frame to support a roll 15 of roofing material to be applied (as seen in FIG. 3). An application roller 16, supported from the frame 10 in trailing engagement with a surface to receive the roofing material, receives and guides the web of roofing material 17 as it unrolls from the support bar 14 and presses the roofing material to the surface (as seen in FIG. 4) with mild downward application of force on the handle 12. Alternatively the application roller may be weighted to press the roofing material onto the surface. A tear sheet take-up roller 18 receives the tear sheet 19 (as seen in FIG. 3). The take-up roller 18 is supported on a second support bar or axle 20 and extracts the tear sheet from the roll as the roofing material is unrolled for application.

To accomplish extraction of the tear sheet 19, the take-up roller 18 employs a drive system operated by one or both wheels 21 through a drive belt 22 engaged by a drive pulley 24 and a driven pulley 25. For the embodiment shown, the driven pulley is carried by the axle 20 which then rotates the take-up roller. The sizing of the drive pulley 24, driven pulley 25 and take-up roller 18 are determined to provide nominal take-up force and rotational speed to extract the tear sheet as the roofing material is unrolled. The drive system is adapted to provide slippage when the take-up roller 18 has received an amount of tear sheet to create a predetermined diameter that would otherwise bind the drive mechanism due to increasing diameter of the take-up roll. This may be accomplished with the drive belt 22 which may be engaged frictionally by the pulleys 24, 25 to allow slippage with respect to the pulleys upon reaching the predetermined diameter. Alternatively, frictional engagement between the take-up roller 18 and axle 20 may be employed to provide the desired slippage in the drive system.

As seen in FIGS. 1 and 2, the support bar 14 is removable to be inserted in the roofing roll. Receiving hooks 26 extending from the frame 10 engage the support bar to removably secure it to the frame. The support bar 14 may be inserted axially into the roofing material roll core and the roll then lifted into position and the support bar placed into the hooks. Bumpers 27 extend laterally from the frame 10 adjacent the receiving hooks to engage the roofing material roll to keep the roll centered for alignment. For the exemplary embodiment the take-up roller is supported on axle 20 by arms 28 extending from the frame 10 and the application roller 16 is supported by legs 29 depending from the frame 10. Relative positioning of the arms 28 and legs 29 may be established based on roofing material roll size and total take-up diameter and for certain embodiments may extend as a common cross bar from the frame 10. An alignment indicator 30 may extend forwardly from the frame 10 to allow easy tracking and specific lap of the previously applied roofing material.

The embodiments shown have the take-up roller positioned to extract a tear sheet from the outer surface of the roofing material roll as it is spooled out. For roofing material rolls in which the tear sheet is positioned on the inner surface of the roll as spooled, the arms 28 supporting the take-up roller 18 may extend from the rear of the frame upwardly spaced from the application roller legs 29. Operation of the applicator in this embodiment is substantially identical to the disclosed embodiment.

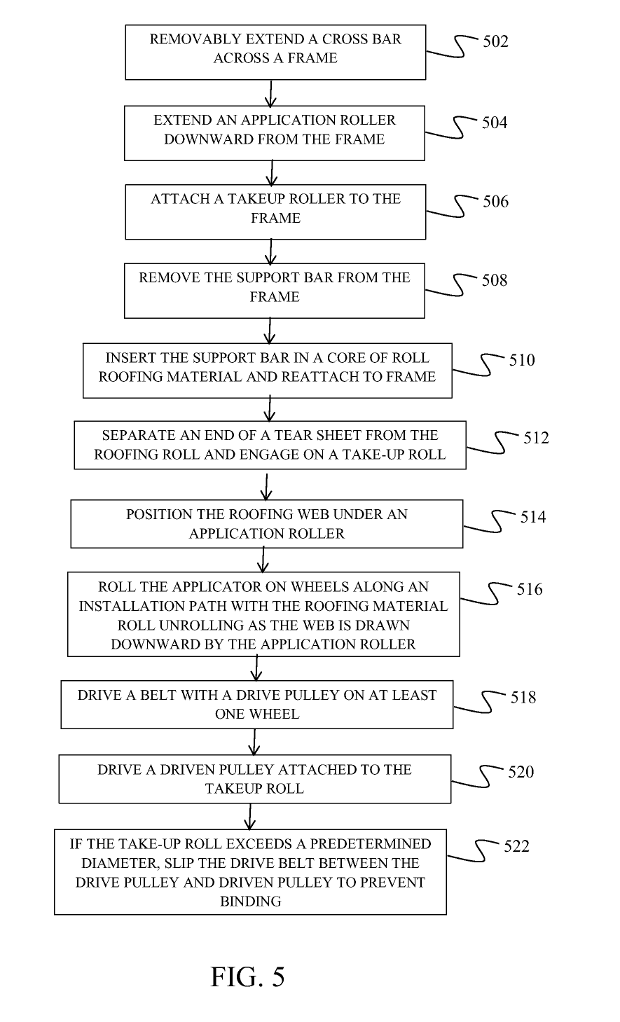

Operation of the applicator in the described embodiments is shown in FIG. 5. The applicator employs a support bar removably extending across a frame, step 502, with an application roller extended downward from the frame, step 504, and a take-up roller attached to the frame, step 506. The support bar is removed from the frame, step 508, and inserted in a core of a roofing roll, step 510. The end of a tear sheet is separated from the roofing roll and engaged on a take-up roll, step 512. The roofing web is positioned under the application roller, step 514, which may be weighted to assist in pressing the roofing material onto the roof The applicator is then rolled on wheels along an installation path with the roofing material roll unrolling as the web is drawn downward by the application roller, step 516. A drive belt is driven by at least one wheel on a drive pulley, step 518, and engaged to drive a driven pulley attached to rotate the take-up roll, step 520. If the take-up roll exceeds a predetermined diameter, the drive belt slips between the drive pulley and driven pulley to prevent binding, step 522.

Having now described various embodiments in detail as required by the patent statutes, those skilled in the art will recognize modifications and substitutions to the specific embodiments disclosed herein. Such modifications are within the scope and intent of the present disclosure as defined in the following claims.

1. An applicator for roll roofing materials comprising:
a frame;
a support bar removably engaged on the frame, said support bar receiving a roofing material roll having a removable tear sheet;
an application roller supported from the frame in trailing engagement with a roofing surface;
a take-up roller supported by the frame and engaging the tear sheet from the roofing material roll, said take-up roller rotatable to roll the tear sheet thereon;
wheels attached to the frame;
a drive system providing
a drive pulley attached to a wheel;
a driven pulley attached to rotate the take-up roller; and,
a drive belt extending from the drive pulley to the driven pulley, said drive belt in slipping engagement with the driven pulley upon the rolled tear sheet reaching a predetermined diameter on the take-up roller.

2. The applicator as defined in claim I wherein the take-up roller is supported from the frame by arms extending from the frame and an axle extending between the arms to rotatingly carry the take-up roller.

3. The applicator as defined in claim 2 wherein the driven pulley is attached to the axle.

4. (canceled)

5. (canceled)

6. The applicator as defined in claim 1 wherein the application roller is supported from the frame with legs extending from the frame.

7. The applicator as defined in claim 1 wherein the support bar is removably engaged by hooks on the frame.

8. The applicator as defined in claim 1 further comprising bumpers extending from the frame to engage the roofing material roll.

9. A method for application of roll roofing material having a tear sheet comprising:
removably extending a support bar across a frame;
extending an application roller downward from the frame;
attaching a take-up roller to the frame;
removing the support bar from the frame;
inserting the support bar in a core of a roofing roll and reattaching the support bar across the frame;
separating the end of a tear sheet from a web of the roofing roll engaging the tear sheet on a take-up roll;
positioning the web under the application roller;
rolling the applicator on wheels along an installation path with the roofing roll unrolling as the web is drawn downward by the application roller;
driving a drive belt by at least one wheel on a drive pulley;
driving a driven pulley attached to rotate the take-up roll with the drive belt; and,
if the take-up roll exceeds a predetermined diameter, slipping the take-up roller.

10. The method as defined in claim 9 wherein the step of slipping the take-up roller comprises slipping the drive belt on one of the drive pulley or driven pulley.

11. The method as defined in claim 9 wherein the step of attaching the take-up roller to the frame comprises inserting an axle through the take-up roller and supporting the axle with arms from the frame and the step of slipping the take-up roller comprises slipping the take-up roller on the axle.
